(19) United States
(12) Patent Application Publication
(10) Pub. No.: US 2023/0365178 A1
(43) Pub. Date: Nov. 16, 2023

(54) COLLAPSIBLE CART

(71) Applicants: Jonathan Kyle Pinto, Toronto (CA); William Charles Howard Cane, Toronto (CA)

(72) Inventors: Jonathan Kyle Pinto, Toronto (CA); William Charles Howard Cane, Toronto (CA)

(21) Appl. No.: 18/093,011

(22) Filed: Jan. 4, 2023

Related U.S. Application Data
(60) Provisional application No. 63/340,572, filed on May 11, 2022.

(51) Int. Cl. B62B 3/02; B62B 3/00; B62B 5/06

(52) U.S. Cl. CPC B62B 3/022; B62B 3/004; B62B 5/067; B60B 33/02

(57) ABSTRACT

Disclosed is a fixed and mobile-capable collapsible cart (100) that includes a plurality of wheel extend levers (102a, and 102b); a first engage surface (104); a first control surface (106); a first control carriage (108a); connection cables (110a, and 110b); swivel caster trunnions (112a); a locking dog (114); a locking catch (116); and casters (118, and 120). The wheel extend levers (102a, and 102b) are pulled to facilitate the first engage surface (104) to contact with the first control surface (106) on the first control carriage (108a) when the fixed and mobile capable collapsible cart (100) is in a retracted state. When the wheel extend levers (102a, and 102b) are pulled farther, the first control carriage (108a) rotates and pulls the connection cables (110a) causing the swivel caster trunnions (112a) to rotate towards an extended position. The locking dog (114) snaps over the locking catch (116) present on the end of the first control carriage (108a) when the swivel caster trunnions (112a) are in the extended positions to lock the casters (118) into the extend position. The wheel extend levers (102a, and 102b) are released after snapping of the locking dog (114), over the locking catch (116) and a hand lever torsion spring (201) return to a home position.

### TECHNICAL FIELD

The present invention relates to a fixed and mobile capable collapsible cart, in particular to a collapsible cart to transport goods.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Typically, users struggle to carry their goods (i.e., groceries, store purchases, etc.) from stores back to their vehicles or directly back to their residences on foot. Many collapsible carts are commercially available for users to transport goods between locations such as grocery stores, offices, and residences. Taking this into consideration, regular collapsible carts do not provide the combination of features such as: being mechanized with collapsible wheels and a handle to act as both a fixed and mobile unit, lightweight, designed to be carried, made with recycled materials, designed for general consumer errands with a small and efficient storage footprint and also these collapsible carts are not aesthetically pleasing.

There are many collapsible carts disclosed in the prior arts such as U.S. Pat. No. 6,916,028B2 which talks about a wheeled carrier device provided which, in one embodiment, includes a plurality of foldable walls supported on a base member and movable between an erected state wherein the walls define a carrier space and a collapsed state wherein the walls are folded on top of the base member. The U.S. Pat. No. 6,916,028B2 does function as a wheeled carrying device but is not designed to also function as a stationary crate. In other words, this patent is designed to exist in a folded state or a wagon state with no ability to function as a fixed crate. Furthermore, this patent has a handle for the wagon that nests or folds into the base rather than using a telescopic mechanism.

Canadian patent CA2458773C discloses a folding crate having a translating hinge arrangement that allows a sidewall of the crate to freely translate in a vertical direction when rotated into a folded position. By allowing opposing side walls to move vertically relative to a bottom component of the crate when folded, subsequent overlapping sidewalls will lay substantially flat and parallel to the bottom component when folded thereon. Thus. CA2458773C does function as a stationary folding crate but does not have wheels or any other mobilization mechanism.

U.S. Pat. No. 6,733,026B1 describes a folding cart that has a forward section, the main section, and a rear section, along with forward and rear end rails and left and right-side rails. The forward and rear portions of the left and right-side rails fold to a coplanar position with the main portion of each respective side rail, while the forward and rear end rails fold down to a position coplanar with the forward section and rear section, respectively. The forward and rear sections may then be rotated to a position over the main section. The forward and rear sections each have mounted to their bottom surfaces a dual wheel assembly, each dual wheel assembly having a pair of wheels that may be folded to a position parallel to their respective forward or rear section. The forward dual wheel assembly is mounted to the front section of the folding cart with a rotating pivot, while the rear dual wheel assembly is mounted directly to the rear section. Thus, U.S. Pat. No. 6,733,026B1 does function as a wheeled cart but does not allow for items to be transported in an enclosed area.

U.S. Pat. No. 6,845,991B1 talks about a wagon or cart constructed for being easily deployed from a fully folded, stowed configuration into a fully erected and usable position. Thus, U.S. Pat. No. 6,845,991B1 does function as a wheeled wagon but does not allow goods to be transported in an enclosed area. Furthermore, the patent has a folding mechanism where the base folds.

U.S. Pat. No. 9,561,815B2 discloses a cart with easy accommodation of a handle by a spring, and a cart with easy accommodation of a handle by a spring in which a handle is easily accommodated under a cart capable of loading articles to carry by using a restoring force of a spring. Thus, U.S. Pat. No. 9,561,815B2 does function as a wheeled device with a folding handle but does not have any folding functionality or contain an enclosed area to contain items.

Further, U.S. Pat. No. 4,856,810A describes a collapsible transport cart having down-folding side and end panels is disclosed. The side and/or end panels are spring-biased in directions to assist the user in converting the cart from a collapsed to an operative configuration. A tow bar/handle is attached to the front of the cart to be generally pivotal in a vertical plane. Thus, U.S. Pat. No. 4,856,810A does function as a folding mobile cart but does not have any functionality to allow the wheels to retract.

The existing bags and options are frail, uncomfortable, and most infamously, not environmentally friendly. Further, the existing prior arts do not have aesthetics and do not provide functional solutions for people to carry their physical goods.

Thus, in view of the above, there is a long-felt need in the industry to address these deficiencies and inadequacies. This specification recognizes that there is a necessity for an efficient and improved fixed and mobile capable collapsible cart with retractable wheels and a telescopic handle.

Further limitations and disadvantages of conventional approaches will become apparent to one of ordinary skill in the art through the comparison of described systems with some aspects of the present disclosure, as set forth in the remainder of the present application and with reference to the drawings.

### SUMMARY

A fixed and mobile-capable collapsible cart is provided substantially, as shown in and/or described in connection with at least one of the figures.

An aspect of the present disclosure relates to a fixed and mobile-capable collapsible cart that includes a plurality of wheel extend levers; a first engage surface; a first control surface; a first control carriage; a plurality of connection cables; a plurality of swivel caster trunnions; a locking dog; a locking catch; and a plurality of casters. The wheel extend levers are pulled to facilitate the first engage surface to contact with the first control surface on the first control carriage when the fixed and mobile capable collapsible cart is in a retracted state. When the wheel extend levers are pulled farther, the first control carriage rotates and pulls the connection cables causing the swivel caster trunnions to rotate toward an extended position. The locking dog snaps over the locking catch present on the end of the first control carriage when the swivel caster trunnions are in the extended positions to lock the casters into the extended position. The wheel extend levers are released after snapping the locking dog, over the locking catch and a hand lever torsion spring return to a home position.

In an aspect, the fixed and mobile-capable collapsible cart includes a plurality of retract buttons to retract the casters upon receiving a push gesture from a user.

In an aspect, the retract buttons move the locking dog out of the locked position and release the locking catch.

In an aspect, the fixed and mobile-capable collapsible cart includes a plurality of trunnion torsion springs to spring return the connection cables, the swivel caster trunnions, the rigid caster trunnions, and the first control carriage back to the retracted state (a start position) for a complete extend and retract cycle.

In an aspect, the wheel extend levers include a front hand lever and a rear hand lever.

In an aspect, the casters include a plurality of front swivel casters, and a plurality of rear fixed casters.

In an aspect, the front hand lever actuates the front swivel casters, and the rear hand lever actuates the rear fixed casters.

In an aspect, the front swivel casters, and the rear fixed casters operate independently of each other.

In an aspect, the wheel extend levers are pulled to extend the casters.

Accordingly, one advantage of the present invention is that it provides a solution where the fixed and mobile-capable collapsible cart can remain loaded with goods while transported in the trunk of a vehicle whereby the wheels are retracted to prevent the crate from moving.

Accordingly, one advantage of the present invention is that the fixed and mobile-capable collapsible cart can fit into the trunk of a vehicle.

Accordingly, one advantage of the present invention is that the fixed and mobile-capable collapsible cart includes a means for the wheels to retract or fold to prevent the cart from rolling in the trunk of the vehicle.

Accordingly, one advantage of the present invention is that it has a lightweight design, yet is durable and has improved aesthetics for mass consumer appeal.

Accordingly, one advantage of the present invention is that wall panels of the fixed and mobile-capable collapsible cart may have insulating properties to transport temperature-sensitive items.

Accordingly, one advantage of the present invention is that it includes a fully removable cover that includes hinges so that items can be added to the unit without having to fully remove the removable cover.

Other features of embodiments of the present invention will be apparent from the accompanying drawings and from the detailed description that follows.

Yet other objects and advantages of the present invention will become readily apparent to those skilled in the art following the detailed description, wherein the preferred embodiments of the invention are shown and described, simply by way of illustration of the best mode contemplated herein for carrying out the invention. As we realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates an assembled view of a fixed and mobile-capable collapsible cart, in accordance with a preferred embodiment of the present disclosure;

FIG. 2 illustrates an in-use view of the fixed and mobile-capable collapsible cart, in accordance with a preferred embodiment of the present disclosure:

FIG. 3 illustrates a perspective view of various components of a swivel caster end-retract/extend mechanism of the fixed and mobile-capable collapsible cart, in accordance with a preferred embodiment of the present disclosure;

FIG. 4 illustrates a perspective view of various components of a fixed caster end-retract/extend mechanism of the fixed and mobile-capable collapsible cart, in accordance with a preferred embodiment of the present disclosure:

FIG. 5 illustrates a first perspective view of various components of a retract/extend mechanism, in accordance with a preferred embodiment of the present disclosure:

FIG. 6 illustrates a second perspective view of various components of a retract/extend mechanism of the fixed and mobile-capable collapsible cart, in accordance with a preferred embodiment of the present disclosure; and

FIG. 7 illustrates an isometric view of various components of the retract/extend mechanism of the fixed and mobile-capable collapsible cart, in accordance with a preferred embodiment of the present disclosure.

### DETAILED DESCRIPTION

The present invention is best understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

While, for purposes of simplicity of explanation, the methodology is shown and described as a series of acts, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter.

It must also be noted that, as used in this specification and the appended claims, the singular forms “a,” “an” and “the” include plural referents unless the context dictates otherwise.

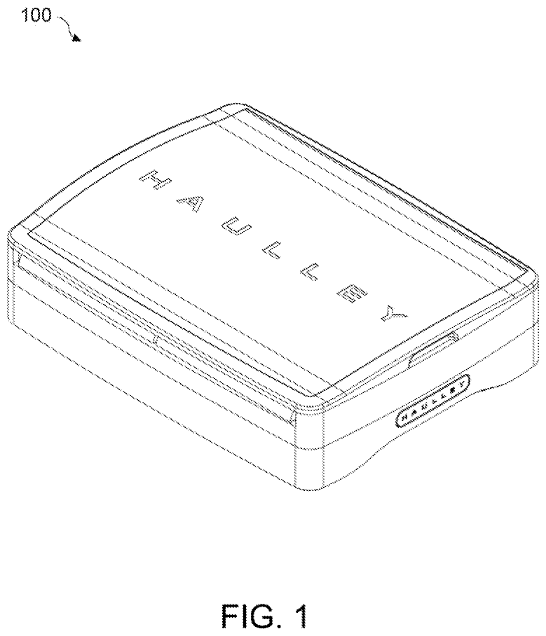

FIG. 1 illustrates a perspective view of a fixed and mobile-capable collapsible cart (100) in a stowed state, in accordance with a preferred embodiment of the present disclosure. The present application discloses a fixed and mobile collapsible cart that provides substantial stability when transporting goods. In an embodiment, the fixed and mobile collapsible cart includes wall panels, and a telescopic handle (205). In the stowed state, the wall panels are folded, the wheels are retracted, and the handle is retracted. This state is applicable when the user wants to stow the fixed and mobile-capable collapsible cart (100) in the most compact manner possible. In addition, the stowed state configuration ensures the unit is protected with the lid acting as a protective shell in the event other items are placed on top of the fixed and mobile-capable collapsible cart (100). The low vertical profile of the stowed state is also applicable for storing the unit under a bed/couch or in the trunk of a car in the most space-efficient manner possible.

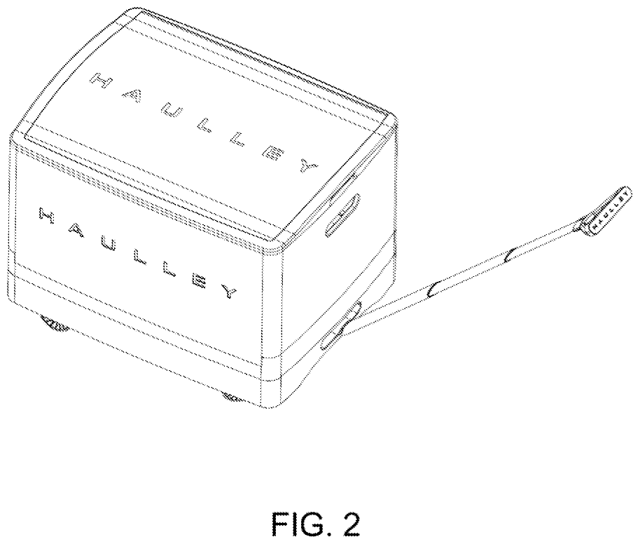

FIG. 2 illustrates an in-use view of the fixed and mobile-capable collapsible cart (100), in accordance with a preferred embodiment of the present disclosure. FIG. 2 is explained in conjunction with FIG. 1. In use, the wall panels are erected, the wheels are deployed, and the handle extended, and the fixed and mobile-capable collapsible cart (100) functions as a trolley to transport goods while the user is in a store or transporting those goods from the store to the user's home/vehicle. When the fixed and mobile-capable collapsible cart (100) is a static crate—with the wall panels erected, the wheels retracted, and the handle retracted, the unit can be used as a crate to hold goods. This is applicable in cases where the user does not want or need the mobility aspect of the unit (such as the case where the unit is being used to transport goods in the trunk of a vehicle). As the unit transitions from a mobile cart to a static crate (in the event the user is loading the unit in the trunk of a vehicle), the user does not need to unload the items from the unit. The same is true when the unit transitions from a static crate to a mobile cart.

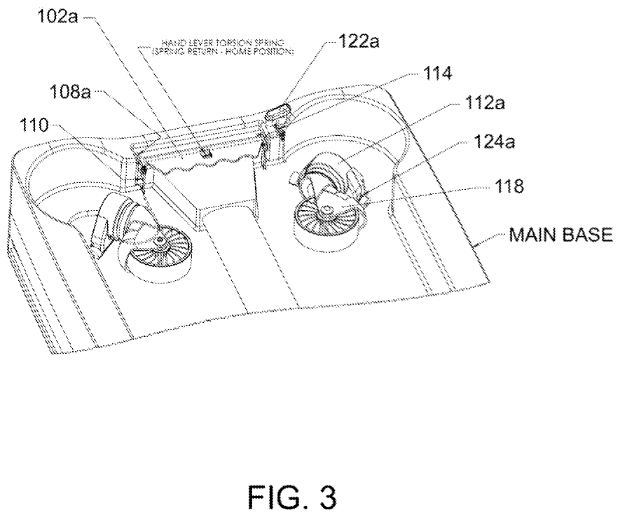

FIG. 3 illustrates a perspective view of various components of a swivel caster end-retract/extend mechanism of the fixed and mobile-capable collapsible cart, in accordance with a preferred embodiment of the present disclosure. FIG. 3 is explained in conjunction with FIGS. 1-2. The wall panels are foldable and fold flat into a base (203) of the fixed and mobile collapsible cart. In one embodiment, the telescopic handle (205) is attached to at least one of the wall panels. Each wall panel may be curved or straight on the inside. All wall panels may each have their combination of being straight or curved on the inside and outside. The wall panels may have square or rounded edges or any combination thereof along all of the edges. In an embodiment, the wall panels may have the ability to fold into the base of the cart in a set or varying order on top of each other. The collapsing or erecting of the wall panels may be mechanized or by hand moved into their vertical position. The wall panels may fold in any order and may be secured using latches, magnets, or any other suitable method to secure the wall panels in the folded position. When the wall panels are unfolded (vertical, and square formation), there may be a mechanism using latches, magnets, or any other suitable method to secure the wall panels in the unfolded position.

In another embodiment, the telescopic handle is attached to the base (203) of the cart to provide structural integrity. The telescopic handle (205) allows for pulling or pushing the fixed and mobile collapsible cart. In an embodiment, the fixed and mobile collapsible cart includes one or more static carrying handles along the top of at least two of the wall panels so that it can be picked up and carried when the wall panels are not folded flat. The wheels are located in the base (203). The wheels may fold flat against the base, retract into the base (203), or perform any other suitable action to withdraw from their open position. At least one of the wheels is steerable, with the other wheels in a fixed position. When the wheels are retracted, and the telescopic handle (205) is collapsed/stowed, the fixed and mobile collapsible cart can operate as a fixed and sturdy crate.

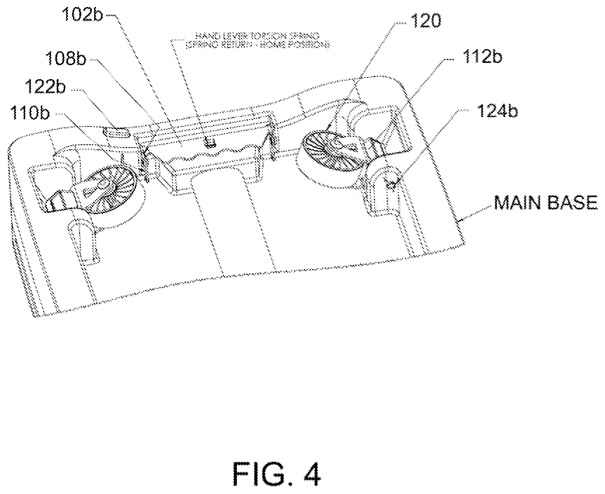

The fixed and mobile-capable collapsible cart (100) that includes a plurality of wheel extend levers (102a, and 102b); a first engage surface (104); a first control surface (106); a first control carriage (008a); a plurality of connection cables (110a, and 110b); a plurality of swivel caster trunnions (112a); a locking dog (114); a locking catch (116); and a plurality of casters (118, and 120). In an embodiment, the casters (118, and 120) are undriven wheels designed to be attached to the fixed and mobile-capable collapsible cart (100) to enable the fixed and mobile-capable collapsible cart (100) to be moved. FIG. 4 illustrates a perspective view of various components of a fixed caster end-retract/extend mechanism of the fixed and mobile-capable collapsible cart, in accordance with a preferred embodiment of the present disclosure. FIG. 4 is explained in conjunction with FIGS. 1-3. The wheel extend levers (102a, and 102b) are pulled to facilitate the first engage surface (104) to contact with the first control surface (106) on the first control carriage (108a) when the fixed and mobile capable collapsible cart (100) is in a retracted state. When the wheel extend levers (102a, and 102b) are pulled farther, the first control carriage (108a) rotates and pulls the connection cables (110a) causing the swivel caster trunnions (112a) to rotate towards an extended position. The locking dog (114) snaps over the locking catch (116) present on the end of the first control carriage (108a) when the swivel caster trunnions (012a) are in the extended positions to lock the casters (118) into the extend position. The wheel extend levers (102a, and 102b) are released after snapping of the locking dog (114), over the locking catch (116) and a hand lever torsion spring (201) returns to a home position.

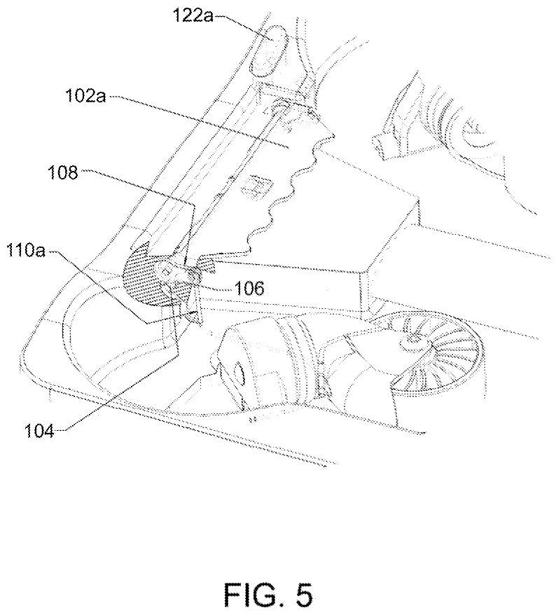

FIG. 5 illustrates a first perspective view of various components of a retract/extend mechanism, in accordance with a preferred embodiment of the present disclosure. FIG. 5 is explained in conjunction with FIGS. 1-4. The fixed and mobile-capable collapsible cart (100) includes a plurality of retract buttons (122a, and 122b) to retract the casters (118, and 120) upon receiving a push gesture from a user. Alternatively, this mechanism can be designed to work in reverse. For example, the retract buttons (122a, and 122b) can also be used to extend the wheels and the telescope handle can be used to retract the wheels.

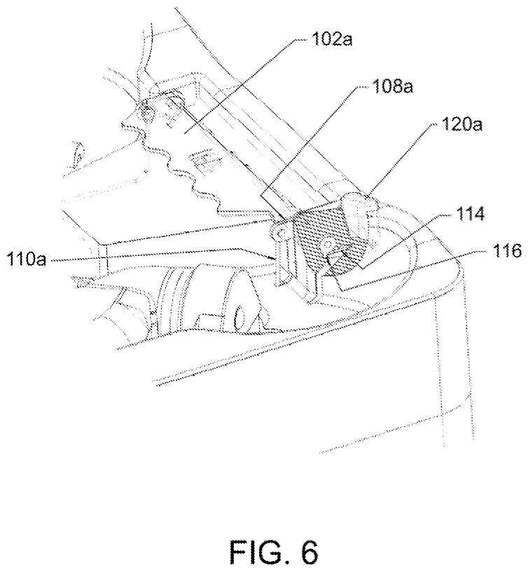

FIG. 6 illustrates a second perspective view of various components of a retract/extend mechanism of the fixed and mobile-capable collapsible cart, in accordance with a preferred embodiment of the present disclosure. FIG. 6 is explained in conjunction with FIGS. 1-5. The retract buttons (122a, and 122b) move the locking dog (114) out of the locked position and release the locking catch (116).

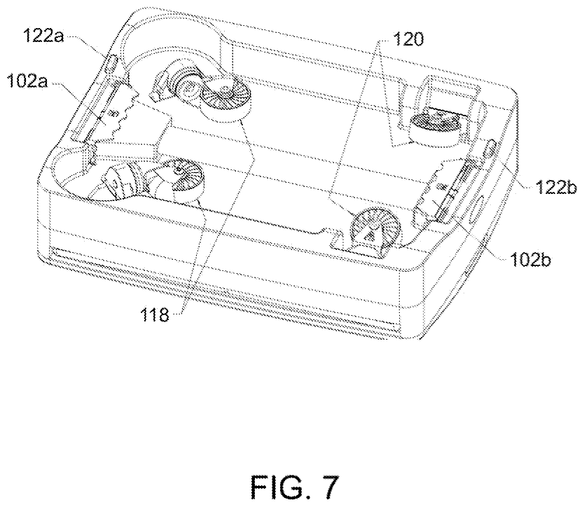

FIG. 7 illustrates an isometric view of various components of the retract/extend mechanism of the fixed and mobile-capable collapsible cart, in accordance with a preferred embodiment of the present disclosure. FIG. 7 is explained in conjunction with FIGS. 1-6. The fixed and mobile-capable collapsible cart (100) includes a plurality of trunnion torsion springs (124a, and 124b) to spring return the connection cables (110a, and 110b), the swivel caster trunnions (112a), the rigid caster trunnions (112b), and the first control carriage (108a) back to the retracted state (a start position) for a complete extend and retract cycle.

The wheel extend levers (102a, and 102b) include a front hand lever (102a) and a rear hand lever (102b). The casters (118, and 120) include a plurality of front swivel casters (118), and a plurality of rear fixed casters (120). The front hand lever (102a) actuates the front swivel casters (118), and the rear hand lever (102b) actuates the rear fixed casters (120). The front swivel casters (118), and the rear fixed casters (120) operate independently of each other. The wheel extend levers (102a, and 102b) are pulled to extend the casters (118, and 120). The wheel extend levers (102a, and 102b) and retract buttons (122a, and 122b) can be used in an opposite configuration. According to an embodiment herein, upon pressing the button to extend the wheels, the user has to pull the wheel extend levers (102a, and 102b) to retract the wheels. Additionally, the positioning of the cable can be reversed to achieve this scenario.

In an embodiment, the cart of the present invention operates in at least four modes i.e., a mobile crate mode, a mobile cart mode, a crate mode, a storage mode, and a briefcase mode.

When the wheels are deployed and the walls are unfolded and vertically in place, the cart of the present invention operates in the mobile crate mode.

When the handle and wheels are deployed, and the walls are unfolded, the cart of the present invention operates in the mobile cart mode for ease of user operation.

When the wall panels are unfolded and in the vertical position, and the wheels and handle are retracted or stowed, the cart of the present invention operates in the crate mode i.e. a fixed and sturdy crate unit.

When the wall panels are folded onto each other, and the wheels and handle are retracted or stowed, the cart of the present invention operates in the storage mode to allow low profile storage.

When the rear wheels are deployed and the user pulls the cart using the partially telescoped handle like a rolling briefcase, the fixed and mobile collapsible can can be used as a briefcase.

In an embodiment, the present invention is designed for a variety of use cases, including but not limited to the 1, can of the present invention in use, and 2. cart of the present invention in storage.

1. The present invention in use:
a) Transporting a user's goods from the store to the car, to their residence: i. The can of the present invention is designed to be able to be taken inside the store where the user can use the cart of the present invention instead of using the available carts or baskets. ii. The user can add goods and/or items directly to their cart and pull it around the store using the handle and wheels. iii. Upon completing their purchase, the user can then retract the handle and wheels to convert the cart of the present invention into crate mode. The cart of the present invention can then be stored in the user's vehicle without the worry of it rolling around. iv. Upon arriving at the user's destination, the user can lift the cart out of their car, deploy the wheels and handle so the cart of the present invention is back in cart mode, and pull the cart of the present invention to their residence/final destination. For example, the user takes their cart into a liquor store and the user loads multiple bottles into the cart and pulls it to the checkout. The user then pulls the cart of the present invention to their car. The user loads the cart into their car and retracts the wheels and handles with the goods still inside. Upon arriving at their residence, the user can unload the can and wheel the goods into their residence without having to carry everything by hand or bags in hand.
b) Transporting a user's goods from the car to their residence: i. The cart of the present invention can be left in crate mode in a user's car. ii. Over a period of time, a user can add things to the cart. iii. At the end of this period, the user can convert the cart into cart mode and pull the cart of the present invention to their destination. For example, over the course of a day, a user runs various errands to buy some groceries, go to the gym, etc. At the end of each activity, the user needs to deposit their goods into the cart located in their car to bring everything back to their residence. At the end of the day, the user converts the cart of the present invention to cart mode and wheels their various goods, bags, etc. into their residence without having to carry everything.
c) Transporting a user's goods from the store to their residence: i. The cart of the present invention can be pulled to and from a store. ii. A user travels from their residence with the cart of the present invention in cart mode to a store. iii. At the store, the user can load the cart of the present invention with various goods as they shop. iv. After purchasing the goods, the user can then pull the cart of the present invention back to their residence. For example, a user walks to a nearby grocery store pulling their cart of the present invention. They pull the cart of the present invention around the grocery store and load their hard goods into it. After purchasing their goods, the user can then pull the cart of the present invention back to their residence.

2. The cart of the present invention in storage:
a. Storage in a vehicle: i. The cart of the present invention can be folded and kept in the back of a vehicle for future use to be readily available for good purchase errands.
b. Storage in a Residence: i. The cart of the present invention can be folded and stored under a bed or neatly in a closet due to its low folded profile for easy storage.

Throughout the specifications of the present disclosure, the term “comprising” means including but not necessarily to the exclusion of other elements or steps. In other words, the term comprising indicates an open list. Furthermore, all directional references (such as but not limited to, upper, lower, inner, outer, upward, downward, inwards, outwards, right, left, rightward, leftward, inside, outside, top, bottom, above, below, vertical, horizontal, clockwise, and counter-clockwise, lineal, axial and/or radial, or any other directional and/or similar references) are only used for identification purposes to aid the reader's understanding of illustrative embodiments of the present disclosure, and may not create any limitations, particularly as to the position, orientation, or use unless specifically set forth in the claims. Moreover, all directional references are approximate and should not be interpreted as exact, but rather as describing a general indicator as to an approximate attitude.

Similarly, joinder references (such as but not limited to, attached, coupled, connected, accommodated, and the like and their derivatives) are to be construed broadly and may include intermediate members between a connection of segments and relative movement between segments. As such, joinder references may not necessarily infer that two segments are directly connected and in fixed relation to each other.

In some instances, components are described with reference to “ends” having a particular characteristic and/or being connected with another part. However, those skilled in the art will recognize that the present disclosure is not limited to components that terminate immediately beyond their points of connection with other parts. Thus, the term “end” should be interpreted broadly, in a manner that includes areas adjacent, rearward, forward of, or otherwise near the terminus of a particular segment, link, component, part, member, or the like. Additionally, all numerical terms, such as but not limited to, “second”, “second”, “third”, “fourth”, or any other ordinary and/or numerical terms, should also be taken only as identifiers, to assist the reader's understanding of the various embodiments, variations and/or modifications of the present disclosure, and may not create any limitations, particularly as to the order, or preference, of any embodiment, variation and/or modification relative to, or over, another embodiment, variation and/or modification.

As will be readily apparent to those skilled in the art, the present invention may easily be produced in other specific forms without departing from its essential characteristics. The present embodiments are, therefore, to be considered as merely illustrative and not restrictive, the scope of the invention being indicated by the claims rather than the foregoing description, and all changes which come within therefore intended to be embraced therein. Many variations, modifications, additions, and improvements are possible. More generally, embodiments in accordance with the present disclosure have been described in the context of preferred embodiments. Functionalities may be separated or combined in procedures differently in various embodiments of the disclosure or described with different terminology. These and other variations, modifications, additions, and improvements may fall within the scope of the disclosure as defined in the appended claims.

While embodiments of the present invention have been illustrated and described, it will be clear that the invention is not limited to these embodiments only. Numerous modifications, changes, variations, substitutions, and equivalents will be apparent to those skilled in the art, without departing from the scope of the invention, as described in the claims.

I/We claim:

1. A fixed and mobile-capable collapsible cart (100), comprising:
a plurality of wheel extend levers (102a, and 102b);
a first engage surface (104);
a first control surface (106);
a first control carriage (108a), wherein the wheel extend levers (102a, and 102b) are pulled to facilitate the first engage surface (104) to contact with the first control surface (106) on the first control carriage (108a) when the fixed and mobile capable collapsible cart (100) is in a retracted state;
a plurality of connection cables (110a, and 110b);
a plurality of swivel caster trunnions (112a), wherein, when the wheel extend levers (102a, and 102b) are pulled farther, the first control carriage (108a) rotates and pulls the connection cables (110a) causing the swivel caster trunnions (112a) to rotate towards an extended position;
a locking dog (114);
a locking catch (116); and
a plurality of casters (118, and 120), wherein the locking dog (114) snaps over the locking catch (116) present on the end of the first control carriage (108a) when the swivel caster trunnions (12a) are in the extended positions to lock the casters (118) into the extend position, wherein the wheel extend levers (102a, and 102b) are released after snapping of the locking dog (114), over the locking catch (116) and a hand lever torsion spring (201) return to a home position.

2. The fixed and mobile-capable collapsible cart (100) according to claim 1 comprises a plurality of retract buttons (122a, and 122b).

3. The fixed and mobile-capable collapsible cart (100) according to claim 2, wherein the retract buttons (122a, and 122b) retract the casters (118, and 120) upon receiving a push gesture from a user.

4. The fixed and mobile-capable collapsible cart (100) according to claim 2, wherein the retract buttons (122a, and 122b) move the locking dog (114) out of the locked position and release the locking catch (116).

5. The fixed and mobile-capable collapsible cart (100) according to claim 1 comprises a plurality of trunnion torsion springs (124a, and 124b) to spring return the connection cables (010a, and 110b), the swivel caster trunnions (112a), the rigid caster trunnions (112b), and the first control carriage (108a) back to the retracted state (a start position) for a complete extend and retract cycle.

6. The fixed and mobile-capable collapsible cart (100) according to claim 1, wherein the wheel extend levers (102a, and 102b) comprise a front hand lever (102a) and a rear hand lever (102b).

7. The fixed and mobile-capable collapsible cart (100) according to claim 1, wherein the plurality of casters (118, and 120) comprising a plurality of front swivel casters (118), and a plurality of rear fixed casters (120).

8. The fixed and mobile-capable collapsible cart (100) according to claims 6 and 7, wherein the front hand lever (102a) actuates the front swivel casters (118), and the rear hand lever (102b) actuates the rear fixed casters (120).

9. The fixed and mobile-capable collapsible cart (100) according to claim 7, wherein the front swivel casters (118), and the rear fixed casters (120) operate independently of each other.

10. The fixed and mobile-capable collapsible cart (100) according to claim 1, wherein the wheel extend levers (102a, and 102b) are pulled to extend the casters (118, and 120).
